(19) United States
(12) Patent Application Publication
(10) Pub. No.: US 2015/0046341 A1
(43) Pub. Date: Feb. 12, 2015

(54) Apparatus for Customer Relations Management

(71) Applicants: Fang Cheng, Mountain View, CA (US); Zhichen Xu, Mountain View, CA (US)

(72) Inventors: Fang Cheng, Mountain View, CA (US); Zhichen Xu, Mountain View, CA (US)

(21) Appl. No.: 14/452,922

(22) Filed: Aug. 6, 2014

Related U.S. Application Data
(60) Provisional application No. 61/863,153, filed on Aug. 7, 2013.

(51) Int. Cl. G06Q 30/00; G06Q 30/02

(52) U.S. Cl. CPC G06Q 30/016; G06Q 30/0281
USPC 705/304

(57) ABSTRACT

An apparatus has a server connected to a network, the server including a processor coupled to at least one data repository and software executing on the processor from a non-transitory medium, the software providing a service comprising receipt of a transaction record related to a transaction between a business and a customer, the record in the form of a digital file generated at a location of the business, processing of the transaction record, determining contextual meaning of individual portions of the record, inserting into the record an executable link on or proximate a portion processed for contextual meaning, the link to a resource associated with the contextual meaning of the portion linked, and transmitting the record with the inserted link to the customer.

### CROSS-REFERENCE TO RELATED DOCUMENTS

The present patent application is a non-provisional application of provisional application 61/863,153, filed on Aug. 7, 2013 and entitled, “Apparatus for Customer Relations Management”. Disclosure of prior applications is incorporated herein in its entirety by reference.

### BACKGROUND OF THE INVENTION

1. Field of the Invention

The present invention is in the field of telecommunications including network communications and pertains particularly to methods and apparatus for establishing communication capability from a transaction record or facsimile thereof.

2. Discussion of the State of the Art

In the field of telecommunications businesses engaged in selling goods and services to the public often manage communication with their customers by utilizing call center services, Web hosting services, sales force applications, and other communications vehicles. Many businesses manage multiple store or service locations where the public aggregate and engage in transactions.

A problem with current communications vehicles relative to customer engagement with businesses is that there are often too few public interfaces through which questions about products might be asked, or complaints might be registered, or product or service related issues might be handled. Physical complaint or product return desks at retail locations might be busy with long lines, there may be long wait times calling a single help line or complaint desk number.

Another challenge with current communications is the amount of work required from the customer in the way of navigation to specific interfaces and having the correct data required by the business from the customer to establish, first of all, the fact that the customer actually engaged in the transaction at issue (proof of purchase), and further that the issue, or question, or problem is clearly explained including identification of certain critical parameters such as identification of service persons involved with the issue and so on. Such inconveniences may impede the customer's goal of getting the issue, matter, question, etc. resolved leaving the customer with a bad experience that may later reflect upon the business through poor user ratings, public complaints, loss of future business, etc.

Therefore, what is clearly needed is an apparatus that reduces or eliminates much of the work required of a customer attempting to communicate with a business about a product or service the customer has patronized.

### BRIEF SUMMARY OF THE INVENTION

In an embodiment of the invention an apparatus is provided, comprising a server connected to a network, the server including a processor coupled to at least one data repository and software executing on the processor from a non-transitory medium, the software providing a service comprising receipt of a transaction record related to a transaction between a business and a customer, the record in the form of a digital file generated at a location of the business, processing of the transaction record, determining contextual meaning of individual portions of the record, inserting into the record an executable link on or proximate a portion processed for contextual meaning, the link to a resource associated with the contextual meaning of the portion linked, and transmitting the record with the inserted link to the customer.

In one embodiment the transaction record is a transaction receipt. Also in one embodiment different portions of the transaction record identify the seller and identity of different items purchased by customer, and wherein the seller identification is made a link to an agent of the seller, and identity of items purchased are linked to information sites presenting additional information about the items. Also in one embodiment the transaction record is one of a receipt, an invoice, a shipping notice, a service order, a ticket to travel or to an event, reservation information, or any other document motivated by a transaction between a business and a customer. Still in one embodiment the executable link asserted by the customer initiates a browser application to service a link to a business web site, an email application to generate an email to the business, a telephony application to initiate a voice transaction to a site for the business, a texting application to initiate a text message to an agent for the business, or a chat program to initiate a chat session with an agent of the business.

In one embodiment the executable link has a time limit, after which the link is no longer operable. Also in one embodiment the server provides execution of a communications initiated by the link. Also in one embodiment the service registers a plurality of businesses as subscribers, and processes transaction records from the plurality of businesses, inserting links into the records to initiate communication between the customers and the businesses. In one embodiment transaction records from individual registered businesses are received and processed in batches. And in one embodiment individual ones of the businesses provide templates facilitating processing of their transaction records.

In another aspect of the invention a method is provided, comprising steps (a) receiving at a server connected to a network, the server including a processor coupled to at least one data repository and software executing on the processor from a non-transitory medium, a transaction record related to a transaction between a business and a customer, the record in the form of a digital file generated at a location of the business, (b) processing of the transaction record, determining contextual meaning of individual portions of the record, (c) inserting into the record an executable link on or proximate a portion processed for contextual meaning, the link to a resource associated with the contextual meaning of the portion linked, and (d) transmitting the record with the inserted link to the customer.

In one embodiment of the method the transaction record is a transaction receipt. Also in one embodiment different portions of the transaction record identify the seller and identity of different items purchased by customer, and wherein the seller identification is made a link to an agent of the seller, and identity of items purchased are linked to information sites presenting additional information about the items. Also in one embodiment the transaction record is one of a receipt, an invoice, a shipping notice, a service order, a ticket to travel or to an event, reservation information, or any other document motivated by a transaction between a business and a customer.

In one embodiment the executable link asserted by the customer initiates a browser application to service a link to a business web site, an email application to generate an email to the business, a telephony application to initiate a voice transaction to a site for the business, a texting application to initiate a text message to an agent for the business, or a chat program to initiate a chat session with an agent of the business. Also in one embodiment the executable link has a time limit, after which the link is no longer operable. Still in one embodiment the server provides execution of a communications initiated by the link. In one embodiment the service registers a plurality of businesses as subscribers, and processes transaction records from the plurality of businesses, inserting links into the records to initiate communication between the customers and the businesses. Also in one embodiment transaction records from individual registered businesses are received and processed in batches. And in one embodiment individual ones of the businesses provide templates facilitating processing of their transaction records.

### BRIEF DESCRIPTION OF THE SEVERAL VIEWS OF THE DRAWINGS

FIG. 1 is an architectural overview of a communications network supporting a customer relations platform according to an embodiment of the invention.

FIG. 2 is a sequence diagram depicting interaction between components having connection of the network to the customer relations platform of FIG. 1.

FIG. 3 is a process flow chart depicting steps for digitally optimizing a transaction record for post transaction communications.

FIG. 4 is an exemplary screen shot of a transaction record digitally optimized for post transaction communications according to an embodiment of the invention.

FIG. 5 is a block diagram depicting components and component associations in the customer relations platform of FIG. 1.

FIG. 6 is a process flow chart depicting steps for brokering post-transaction communications between a user and other private individuals connected to the network according to an embodiment of the present invention.

FIG. 7 is a process flow chart depicting steps for auto-handling of a post transaction user request for interaction according to an embodiment of the invention.

### DETAILED DESCRIPTION OF THE INVENTION

In various embodiments described in enabling detail herein, the inventor provides a customer relations management (CRM) platform accessible through a distributed transaction record. The present invention is described using the following examples, which may describe more than one relevant embodiment falling within the scope of the invention.

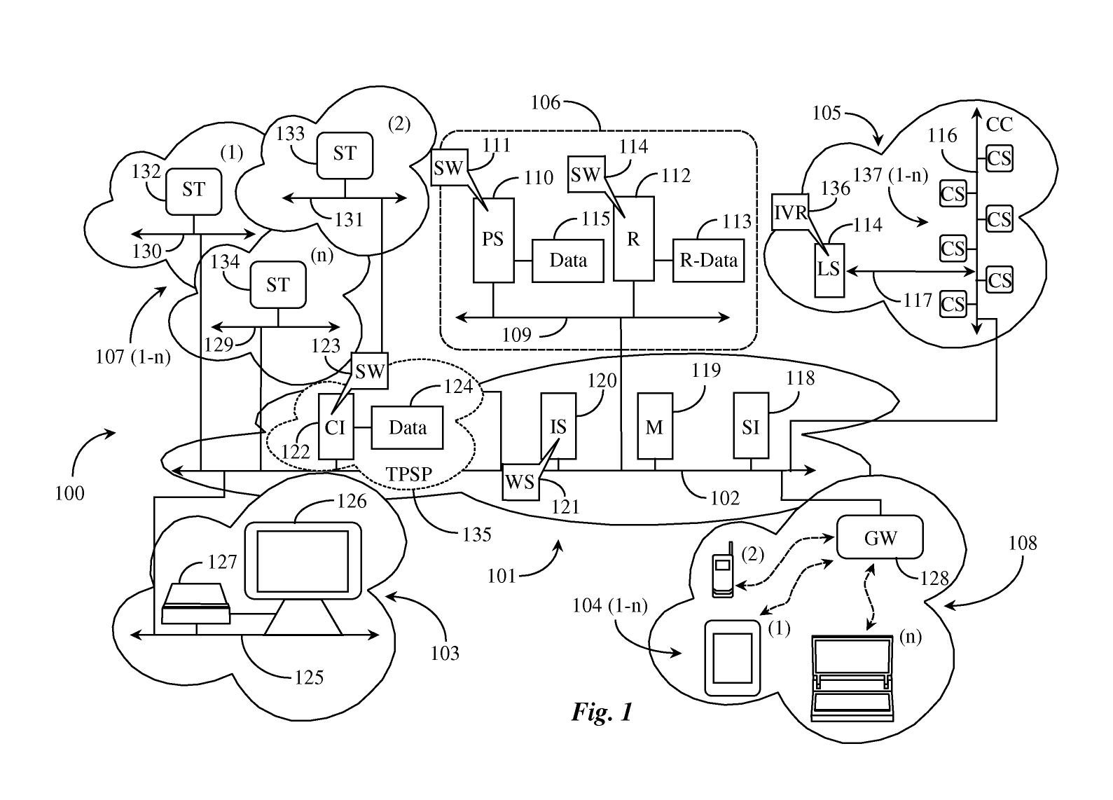

FIG. 1 is an architectural overview of a communications network 100 supporting a customer relations platform according to an embodiment of the invention. Communications network 100 includes at least a portion of the public Internet network 101. Internet network 101 is also represented by an Internet backbone 102. Internet backbone 102 represents all of the lines, equipment and access points that make up the Internet as a whole. Therefore, there are no geographic limitations to the practice of the present invention.

Internet 101 may be a corporate wide area network (WAN) or a municipal area network (MAN) without departing from the spirit and scope of the present invention. Network backbone 102 supports an information server (IS) 120 within Internet 101. Information server 120 includes a processor coupled to at least one processor and memory containing thereon all the data and instruction required to function as a network information server. IS 120 is adapted to host and serve Web pages to users upon request. In this example IS 120 hosts a web site (WS) 121. WS 121 represents a network access point for users and businesses to register or otherwise opt to have access to a customer relations management platform represented herein by a CRM domain 106 (bounded by broken rectangle).

CRM domain 106 includes a local area network (LAN) represented herein by a LAN backbone 109. Backbone 109 may also be referred to hereinafter in this specification as LAN 109. LAN 109 has connection to network backbone 102 via an Internet access line. In one embodiment WS 121 on IS 120 is hosted by a third party web-hosting service. In another embodiment WS 121 is provided and hosted by a third-party providing CRM services according to an embodiment of the present invention. WS 121 provides at least one interface for business users and at least one interface for patrons of those businesses to register for and download any instructions by way of software (SW) that may be made available to aid in integrating those users and user assets into the service of the present invention.

Communications network 100 includes multiplicity or a plurality of business locations 107 (1-n). Locations 107 (1-n) may represent retail store locations or franchises, sales and service locations, or other outlets accessible to customers. Each location 107 (1-n) represents a location where transactions occur during a normal course of business. Each location 107 (1-n) includes at least one sales terminal (ST) connected to a local network such as ST 132 connected to local network 130 at location 107 (1). Likewise locations 107 (2) and 107 (n) include ST 133 connected to local network 131 and ST 134 connected to local network 129. Sales terminals 132-134 are computerized transaction terminals that may or may not be connected to an automated transaction network. Local network segments 129, 130, and 131 associated with locations 107 (1-n) may represent local automated transaction network segments all having connection to network backbone 102.

Business locations 107 (1-n) may vary in business type, products or services sold, and procedures for doing business. The only commonality they may share is the fact that they are networked onto the Internet (101) and that records of transactions are generated and stored in association with customer data and payment methods. For example, one location 107 may be a restaurant while another location may be a fashion outlet or a service center that services automobiles. Any business that generates and stores transaction records on computerized equipment connected to the network may be integrated into the CRM platform of the present invention.

Locations 107 (1-n) may also include online accessibility for users who shop from mobile appliances connected to the network. In this example, such users are represented herein as mobile appliances 104 (1-n) (user operated). Mobile appliances 104 (1-n) may connect to network 101 through a wireless carrier network 108 and a gateway (GW) 128 and subsequently to online access points for sales and services provided by businesses operating at locations 107 (1-n). Users 104 (1-n) may obtain records of their transactions such as receipts, invoices, shipping orders, service orders, and other such records of transactions.

Users 104 (1-n) may, in one embodiment, physically visit locations 107 (1-n) and perform transactions where a record thereof is printed out on paper as a sales receipt or service order and given to the users post transaction. In this case the ST that recorded the transaction retains a simple digital version of the printed receipt for record keeping purposes. In some cases receipts may be transferred from STs to mobile appliances operated by users performing the transactions using near field (NF) wireless technology or other localized wireless communications products.

Users 104 (1-n) may also visit virtual locations made available online for locations 107 (1-n) by connecting to Internet 101 and navigating to appropriate web interfaces providing transaction services for those locations. In this embodiment the users may obtain records of performed transactions via Internet media such as email, text message, account web page, etc. In this case the user has a simple digital receipt.

In this example, a user domain 103 is depicted including a local area or home computing network 125 that supports a computer 126 and a connected document scanner 127. Domain 103 has connection to backbone 102 via Internet access line. In one embodiment where a user only receives a paper transaction record the user may later scan the record onto computer 126 using scanner 127 to obtain a simple digital representation of the receipt.

Communications network 100 includes a third party call center (CC) 105. Call center 105 may be contracted by businesses operation location 107 (1-n) to handle transaction processing and various categories of customer service. In this example CC 105 includes a local area network (LAN) 116 connected to Internet backbone 102 by Internet access line. LAN 116 supports a plurality of connected customer service (CS) points 137 (1-n) represented as a plurality of segregated computer workstations with communications equipment connected to the LAN. CC 105 includes a local telephone switch (LS) 114 having connection to communications equipment such as telephone handsets or headsets provided at each CS 137 (1-n). CC 105 may be operated by any one of businesses 107 (1-n) or a third party operating CC 105 may contract with multiple one of business 107 (1-n). Call centers in embodiments of the invention may also be enabled by software for agents to correspond with callers (customers) by email, text messaging and other forms of communication. It is duly noted herein that a business does not necessarily require a physical location or store front frequented by customers in order to practice the present invention.

Internet backbone 102 supports a third party service provider (TPSP) domain 135. TPSP domain 135 may be a business and or consumer service that is related to businesses patronized by the customer. An example might be a consumer product review and price comparison web-based service. Another example might be a business review website such as Angie's List™ or some other service dedicated to consumers and or the businesses they patronize. TPSP domain 135 includes a customer interaction (CI) server 122. CI server 122 includes a processor at least one coupled data repository such as a data repository 124 and memory containing thereon all of the data and instruction to enable function as a customer interaction server.

CRM domain 106 includes a process server (PS) 110 connected to local area network (LAN) 109. PS 110 includes a processor and at least one coupled data repository like data repository 115 and software (SW) such as SW 111 executing on the server from a non-transitory medium. SW 111 is adapted to receive as input a simple digital record of a transaction that was performed at one of business locations 107 (1-n) or at a virtual location for the business on the Internet, or one scanned and uploaded to server 110 from a computer connected to the network like computer 126 in user domain 103.

In one case, STs 132-134 automatically forward all of the transaction records over Internet 101 to server 110 for optimization. As part of the customer relation platform of the present invention, PS 110 has access to detailed information about businesses it services including contact information, product and service data, and customer data including contact, billing, and purchase history. In one embodiment this detailed information may be periodically uploaded to PS server 110 for storage and later access. In another embodiment the detailed information is maintained (stored in digital format) at the business locations or it is stored at first or third-party sites on the broader Internet network, for example in a third-party computing cloud service or online storage island or facility and made available to PS 110 upon request.

In this example, data repository 115 represents the detailed information mentioned briefly above that is accessed or otherwise obtained from business locations 107 (1-n) and data generated by server 110 as well as detailed information obtained from third party service groups like TPSP 135. SW 111 may contain data extraction and parsing elements to parse or otherwise disseminate the contents of a simple digital record of a transaction so that it may be programmatically understood. SW 111 may optically recognize specific information rendered in the simple digital form of a transaction record. Recognition of the elements in the digital receipt may be aided by platform access to the detailed transaction data (from the business) associated with the record of transaction.

SW 111 may include one or more engines that function to insert or embed into and therefore “distribute” at least one executable link to one or more than one user interface. User interfaces may be provided and dedicated to assisting the user who is associated with the record to enable the user engage in further communications with the business or representatives post transaction. The one or more links to user interfaces may be strategically located in a digital representation of the original record that is forwarded on to the user over the network for display on a computing appliance operated by the user. The links may be browser-based and upon execution cause download and display of the associated interface. The links may be executed from within the digital representation of the original record that was received by the platform for optimization.

In another embodiment links may point to a service that aggregates multiple other services in the form of a portal, or workflows. In the case o the workflow, the services are contextual and optimized to serve a current need of the customer or other user who initiates a link. That is, users may want to track, for example, shipping of an order. In some embodiments users are enabled to specify preferences for communication channels stating delivery state changes.

In one embodiment the inserted or embedded links may also point to other resources such as frequently asked questions (FAQs) Web page or other universal resource locator (URL) addresses for Web-based resources. In one embodiment executable communications links that initiate voice contact with service personnel, email, or messaging with the personnel, interaction with an automated service such as an interactive voice response (IVR) unit such as IVR 136 at LS 114 within CC 105. Users 104 (1-n) may receive optimized records of one or more transactions on their respective mobile appliances through Internet 102 and wireless carrier network 108. Users may initiate content relative interaction and or communications by simple interacting with one or more of the links embedded in the record content.

CRM platform domain 106 includes a router 112 connected to LAN 109. Router 114 includes a processor and at least one data repository coupled thereto and memory containing thereon all the data and instruction required to enable function as a router. In this embodiment, router 112 may be considered a multimedia router for routing communications and interaction requests received at domain 106 as a result of user interaction with links embedded in their received records. It is not required that CRM platform 106 broker the communications in order to practice the present invention. However, in one embodiment further efficiency is afforded in communications by CRM routing assistance and an ability to categorize requests for simpler sorting and processing. Router 112 represents a universal (media) router in one embodiment. In another embodiment there may be more than one router for different request types.

Router 112 has connection to a data repository 113 containing routing (R) data. Routing data 113 may include the descriptive and contact parameters associated with all of the business and third party sales and service entities, departments, call centers, help desks, automated services, Web-based services, etc. Hosted SW 114 aids router 112 in this example. SW 114 functions to analyze routing requests to determine which routing routine and contact details are needed for successful routing of the request. CRM platform 106 may broker communications in one embodiment where PS 110 may function as a proxy server and may determine whether or not to route a request externally based upon whether there is ample information or previous information available internally to satisfy the request.

Internet backbone 102 supports a message server (M) 119, and a social interaction (SI) server 118. Message server 119 includes a processor, at least one coupled data repository and memory containing all of the data and instruction required to enable function as a message server. Message server 119 may be an email server. SI server 118 includes a processor, at least one data repository and a memory containing thereon all of the data and instruction required to enable function as a social interaction network server. CRM platform 106 may stream information in real time to a news feed or some other data feed using real simple syndicate RSS or other animated feed protocols. Users may interact with the platform through social interaction pages such as a home page on SI 118. Users may interact with the platform through message server 119.

In one embodiment platform 106 may route requests externally to third-party service entities such as a third party service provider 135 having connection to Internet backbone 102. TPSP 135 is also depicted as a cloud with a broken boarder. TPSP 135 might be a consumer protection site, a shop and compare site, a product and or service review site, a business listing and rating site, or a variety of other available services accessible online. TPSP 135 includes a customer interaction (CI) server 122. Server 122 includes a processor, at least one data repository coupled thereto and a memory containing thereon all of the data and instruction the enable function as a customer interaction server.

CI 122 has connection to a data repository 124. Data repository 124 contains all of the data necessary to conduct a service such as one of those described above. CI 122 hosts SW 123. SW 123 may be a client application to SW 111 executing on PS server 110 in platform domain 106. In one embodiment a request may come in that requires routing to a third party service provider such as TPSP 135. Server 122 may include one or more user interfaces for enabling interaction with the service including making selections, accessing forms, making comments, filing a complaint, etc.

It is noted herein that the amount of involvement of CRM 106 in post transaction communications may vary. For a business, CRM platform 106 may simply provide record optimization service for the business and does not broker or handle post transaction interactions. Moreover, in applications where CRM platform 106 does broker and handle post transaction communications, those services may be provided in a flexible manner. For example, CRM platform 106 may monitor post transaction communications and record the captured event data to add to purchase or transaction history for that customer. In another embodiment some services communications are monitored while some are not. In another embodiment destinations of routed requests report results of interaction back to the CRM platform.

In one embodiment, a user such as one operating in domain 103, can make a digital record by scanning a document into scanner 127 and the upload that simple digital representation of the record to PS 110 for processing. The record once processed may be mailed, sent by text, or otherwise delivered back to the user over the network. Users operating mobile scanners may also scan in records and have them optimized and returned to them in a format that allows the subsequent post transaction communications by executing links within the displayed record document.

It will be apparent to one with skill in the art of networked services that the CRM platform of the present invention may be provided minimally such as restricted to intercepting, processing, and returning interactive representations of the original service or transaction records. In one embodiment, the CRM platform may perform routing in the event that users interact with the link-optimized records. In one embodiment the CRM platform may broker some post transaction communications including handling messages or other requests for communication where the resources are “in-house”.

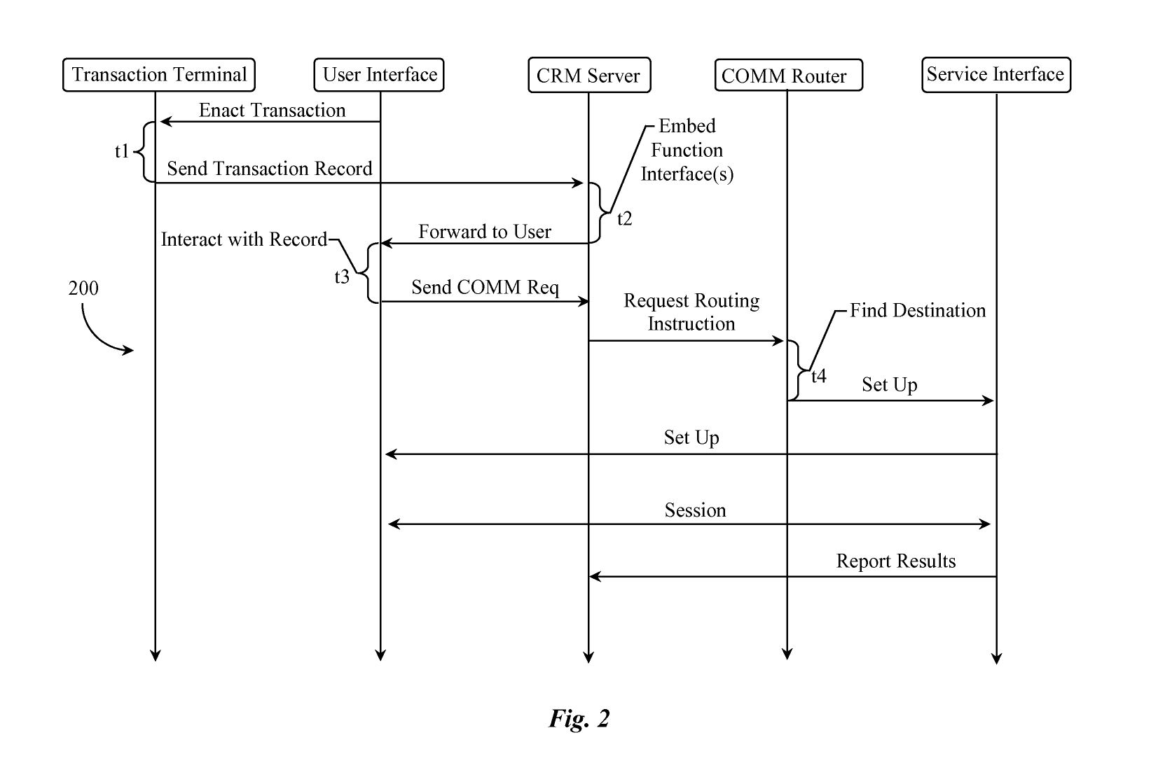

FIG. 2 is a sequence diagram 200 depicting interaction between components of the customer relations platform of FIG. 1. Diagram 200 includes a transaction terminal analogous to any one of sales terminals 132-134 of FIG. 1 above. In one embodiment the transaction record is a sales receipt, shipping order, or service order. Diagram 200 includes a user interface in interaction with the transaction terminal. The user interface is analogous to one of users 104 (1-n) that may physically interact in person with the terminal in the case of a store terminal or over a network in the case of a virtual (digital store or service) location on the network. In this embodiment a user operating from or as a user interface may interact with the transaction terminal to enact a transaction. The time for performing the transaction and producing a record thereof is represented by t1. It is important to note herein that the user may use a smart phone or other wirelessly enabled device to perform the transaction at the terminal. In one embodiment the user may enact the transaction without using a device.

At the expiration of t1, the transaction terminal may send or otherwise transfer the transaction record to a customer relations management (CRM) server. In one embodiment the CRM server monitors for transaction records and retrieves them in batches periodically. In another embodiment the transaction server uploads batch receipts or other transaction records to the server. In one embodiment the records are also given to the users in simple printed form or in simple digital form without optimization in the interim before the optimized version of the record is available.

The CRM server receives or otherwise obtains the records and processes the records to determine the content and then embeds the appropriate links and widgets into the digital form or document during time t2. The CRM server has access to certain data about the user including identification, contact data, records of transaction, purchase history, etc. The CRM server also has access to the relative links, widgets (including user interfaces), and other contact information to optimize the records. At the expiration of t2 the CRM server may forward the optimized digital record back to the user over the network.

If the user performed the transaction at a physical sale terminal in a store, the optimized record may be sent to the communications appliance or device the user is currently operating in the physical proximity of the terminal. In this case the optimized record may appear on the user's device shortly after the transaction occurs and may replace an original printed and or simple digital record that is not optimized. If the transaction occurs over a network with a virtual sales terminal like a virtual checkout, the user may receive an optimized digital record instead of the original non-optimized record normally emailed to a user post transaction. In the case of a printed receipt, the digital copy may be sent to the CRM or the customer may scan in the record to a communications appliance or device and physically send it to the CRM platform for optimization. It is noted that the customer may be required in one embodiment to add some information to the message containing the record for optimization or confirm existing information in the record during analysis.

The user may receive the optimized digital record at the user interface (appliance or device). If the user so chooses, the user may interact with any of the links and or widgets embedded into the record as interactive links. The links may include communications links, links to text or multimedia information sources connected to or otherwise available over the network. The links may include links to widgets like a user calendar, a user interface to some third party service, contact links to help desks, customer service personnel email or message accounts, or telephony voice services including auto attendant services like interactive voice response (IVR) and other contact center interfaces such as chat, FAQs, etc.

A widget may be a calendar, a calculator, or any other tool that might be retrievable by link or functionally embedded in the record. One or more servable user interfaces may be linked to strategic areas in the receipt or record to allow the consumer user to initiate a service request from their receipt or record. A user interface might be a virtual button or link that is embedded into a section of the digital receipt or record where that service is relevant. The capability of programmatically understanding the original simple digital receipt information allows the virtual button or link (or other user interfaces) to be located in close proximity or otherwise in physical association with the relevant information blocks contained in the receipt or record. A user interface may also include form filling or other text interface for the user to input a question, file a complaint or make ratings or other comments.

If the user chooses to interact with the received record the interaction time is represented herein by t3. At the expiration of t3 the result of interaction, such as a request for communication, may be sent to the CRM server for handling in one embodiment. In this embodiment the CRM server is involved in interaction routing and communication brokering or Internet proxy services. In one embodiment the CRM server optimizes the records and is not involved in post transaction communications or other Internet activity that the user may initiate through the optimized record document. In such a case the appropriate links to contact points for the relative post transaction services are embedded and the CRM does not continue monitoring or receiving status about the post transaction interaction between the user and the referred services.

This example includes continued post transaction involvement by the CRM server. In this case the CRM server may receive and queue the communications request resulting from interaction with the optimized record. The CRM server may consult a communications (COMM) router analogous to router 112 of FIG. 1 for routing services. CRM server may request routing instruction based on analysis of the request. The request might be for live voice or live chat. In this embodiment the request is for live real-time communications. The router may determine the appropriate destination to route the request to during t4. The router may set up a session over the network using session initiation protocol (SIP), voice over Internet protocol (VoiP), or other communications protocols including outbound telephony callbacks to user communications devices.

In one embodiment the CRM platform server actively monitors the established communications session for the results of the interaction and may store the data associated with that user. In another embodiment the CRM platform is passive and does not monitor the post transaction activity, but does receive a summary report that may be more or less detailed according to what transpired during the interaction. It will be apparent to one with skill in interaction sequencing that the interaction with the optimized transaction record may result in a request that may be fulfilled by the CRM server with locally stored information where no routing is required. For example, the request may be a link executed to a FAQ about a product listed in the record wherein the FAQ is stored in a repository coupled to the server.

It will also be apparent that the exact depth of integration of the CRM platform to businesses, users, and third-party services individually, or in combination may be flexible and scalable. Minimally, the CRM platform intercepts and optimizes the records of transaction and gets them back to the users who may then interact from within those optimized documents to initiate communications post transaction.

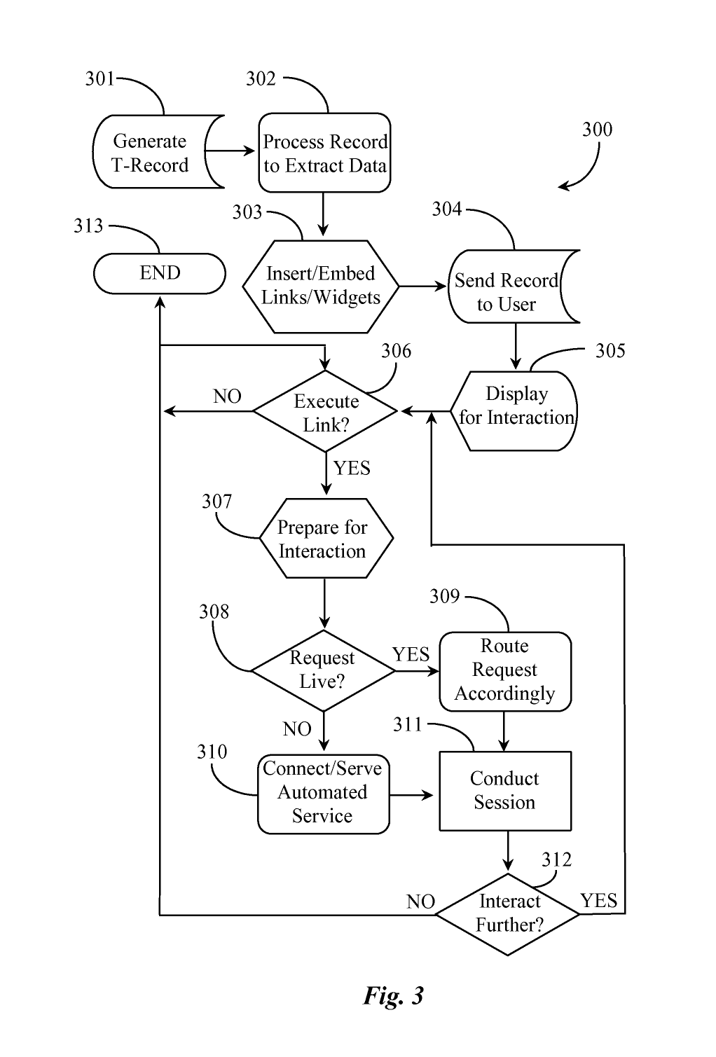

FIG. 3 is a process flow chart depicting a process 300 for digitally optimizing a transaction record for post transaction communications. At step 301 a transaction record (T-Record) is generated at a physical location such as at a sales or service terminal or register, or at a virtual (online) location address on the network (server). Also in step 301 the generated record of transaction is intercepted or forwarded to the CRM platform server for processing. In actual implementation, the records may be periodically sent or otherwise obtained in batches or as they occur in real time.

At step 302, the CRM platform server with the aid of SW processes the record automatically extracting and parsing data from the record. In one embodiment the record of transaction may be a scanned document from a paper receipt or other record. In the processing of the record, the platform learns the relevant sections or blocks of information located on the document and the contents of those blocks and their associations to other information blocks in the record. At step 303 appropriate links and widgets, including one or more user interfaces, are inserted or otherwise embedded into the record at strategic locations which are relevant to the information blocks already located in the record. For example, a receipt having four products listed might include links to a different FAQ relevant to each one of the listed products, the links nested adjacent to or otherwise in physical proximity on the receipt to those listed products.

In one embodiment the links may be graphical icons, text labels, or any other graphical or textual representation. The links might be embedded in the actual product text or other record media content. For example, a logo for a store may be converted into an interactive link to the store Web site. In one embodiment the total paid price on the record may be converted into a link to a user account page where the user is a member of the retail establishment or other business.

The optimized record is sent to the user in step 304 and may then be displayed for interaction on the user's mobile or tethered communications appliance at step 305. A user may determine to interact with or execute any one of the inserted or otherwise embedded links at step 306. If the user determines not to execute links or to otherwise interact with the optimized record at step 306, the process may end for that user at step 313. That is not to say that the user will not interact with the record. The user might still interact with the record at a later time. In one embodiment the links are temporary and set to expire if the user does not interact within a specified period of time. Such constraints might be tied to up sale promotions, certain discount programs, or other services that may be linked to or otherwise embedded into the optimized record.

If the user determines to interact with the transaction record at step 306, the execution of a link results in some preparation for ensuing interaction on the user's appliance at step 307. For example, executing a link to a product FAQ page might cause a browser interface to automatically open on the appliance for navigation to the page. Clicking on a call link or button might result in a telephony application opening on the user's device where the number is automatically dialed.

At step 308 the CRM platform might receive a request for communication and may make a determination if the request is for live services. If the CRM platform determines that the request is for live communications, the request might be routed accordingly at step 309. If the request is not a request for live communication, the CRM platform may connect or serve an automated or “self” service interface to the user at step 310. In one aspect router 309 might be involved in finding the correct automated service destination connected to at step 310. In either case, a session may be established between the user and a destination at step 311.

Request messages routed to a retailer or a brand service team, for example, may include any consumer user input (through widget, interface) in association with the auto embedded information about the referred product and or transaction. Messages may be email, text messages, voice mail, or messages produced by other communication methods. In one embodiment customer input along with product service identification may be presented in consumer or product or sales data feeds coming into business' CRM system or on a designated web portal. Messages including user input and intent can also be directly posted on social network channels including but not limited to Twitter™ or Facebook™.

A user may determine whether to continue with further interaction or quit at step 312. If the user determines to interact further the process may loop back to step 306. If the user decides to quit at step 312 the process may end for that user at step 313. It is noted herein that a user might save a transaction record that has been optimized for a period of time before interacting with it. After interacting through the record, a user may also quit and then return to the record later and interact with the record again.

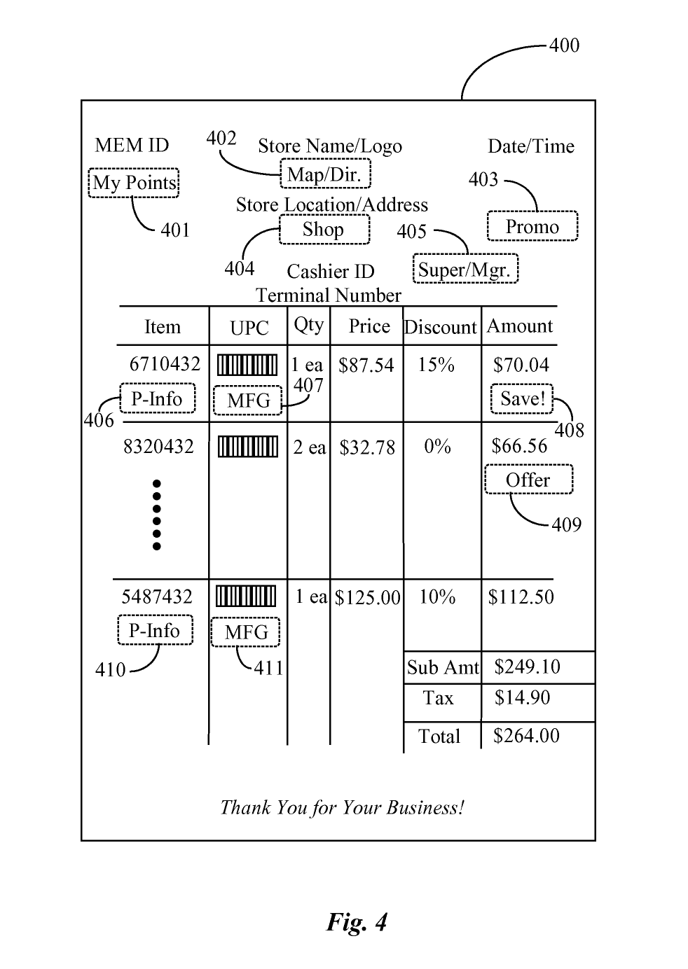

FIG. 4 is an exemplary screen shot of a transaction record 400 digitally optimized for post transaction communications according to an embodiment of the invention. Record 400 may be a receipt, an invoice, a shipping record, a redeemable document, a legal document or contract etc. without departing from the spirit and scope of the present invention. In this example document 400 is a digitally optimized transaction receipt. Receipt 400 might have been generated at a store location having a store name and logo including a store number and address. The user may be a member of the location or establishment and might have a member identification number (MEM ID). Receipt 400 further includes the date and time of the transaction. Receipt 400 further includes the identification of the cashier (Cashier ID) that serviced the user and the terminal number for the register.

Receipt 400 includes an embedded link 401 to a “points” account page labeled “My Points”. It is noted that the link is located under MEM ID and is associated with the user's account page. A link 402 may be provided next to the store name/logo that links to a third-party mapping or contact directory service. Receipt 400 includes a link 403 to a service or product promotional offer. Link 403 may be to an offer specific to a store location or a general offer available storewide. If a promotion is associated with any of the listed products or services on receipt 400 it may be embedded next to or as an overlay on the appropriate entry.

Receipt 400 includes a communications link 405 to a location manager or supervisor that was overseeing the cashier at the time the transaction was generated. Link 405 may be a call back link, a text messaging link, an email address, or a telephone number to a local switch or router that may forward the request over another network like the public switched telephone network.

Receipt 400 includes an accounting (columns and rows) of the transaction or transactions made at the time and data of the receipt. From left to right, the column headings are Item, UPC, Qty, Price, Discount, and Amount. Items are listed by item numbers 6710432, 8320432, and 5487432. There may be more or fewer items listed without departing from the spirit and scope of the present invention. Links 406 and 410 may be links to product information Web pages. Each link may be product specific and may be associated closely to the relevant product entry on the receipt.

Each product has associated thereto a universal product code (UPC) or other identifying code such as a stock-keeping unit (SKU) to help track the products and versions thereof in the inventory or stock of products. In this example the UPC data is presented in bar code format, which can be extracted and read by the CRM platform. Receipt 400 includes manufacturer (MFG) links 407 and 411 to the manufacturer Web sites or customer interaction points or other communications links. Each link is associated on the digital display of the receipt next to the relevant product in the UPC column.

Receipt 400 includes a link 408 to a promotional offer of savings (Save) associated with product 6710432 in the amount column. The link may be to a pop-up user interface offering a savings for purchasing one or more accessories to the product. Similarly, a link 409 is provided to a user interface presenting an up sale offer tied to a “next” purchase of the same product 8320432. Links soliciting consumer feedback and other information may also be provided and inserted or otherwise embedded into receipt 400. Such services may be first or third party hosted interfaces and services.

A record of transaction that is a shipping record or an invoice, or an airline ticket may have links to offers, services, etc. associated with those business and service descriptions. For example a customer patronizing a business that utilizes the CRM platform of the invention may receive two optimized records of transaction, one depicting an itemized purchase transaction (receipt) and another one confirming the product shipping arrangements for the sold products. The links may point only to services and offers relevant to those separate departments of the same business.

It is noted herein that a request for communication from a user may be categorized depending on whether it is regarding a product or a transaction, whether it is a complaint or question, or whether the inquiry requires real-time information. Consequently the request can be directed (routed) to a different service unit or service provider, or the service platform can decide whether stored answers for the question can be used for auto-answering (brokering). For example, a question for checking inventory on a particular product requires real-time input on the inventory information, and although the same question may have been directed to the system before, it may not be able to be used for auto-answering the question. Instead every time the same question is asked, the service platform may need to obtain the answer from the corresponding service unit (real persons or program dedicated to serve the inventory checking service) in a timely manner including any updated information.

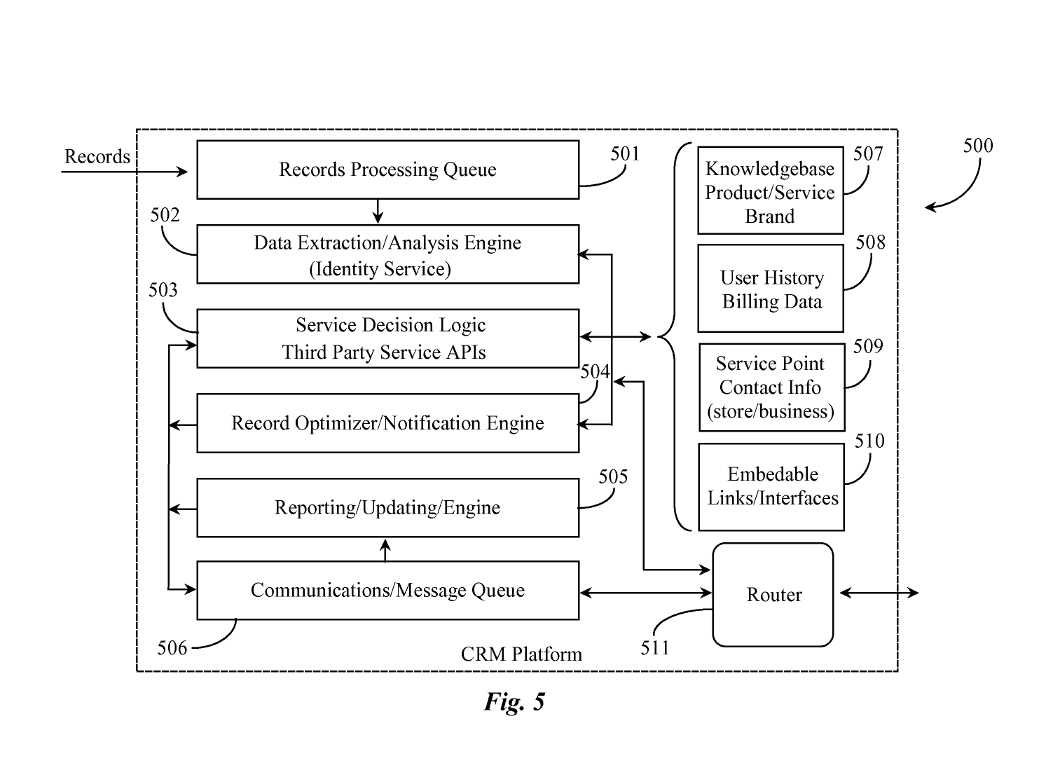

FIG. 5 is a block diagram depicting components and component associations in a customer relations platform 500 according to an embodiment of the present invention. CRM platform 500 may include a records processing queue 501 for queuing transaction records received for optimization. Queue 501 may be a first in first out (FIFO) queue or a prioritized queue. Platform 500 includes a data extraction and an analysis engine 502 that optionally includes an identity service. An identity service for matching transaction records to user may be provided separately.

Platform 500 may include service decision logic 503 for making determinations about request type and destination. Logic 503 may include application program interfaces (APIs) to services registered as third party services with the platform. Platform 500 may include a record optimizing and notification engine 504. Optimizer engine 504 sorts and embeds the links and widgets and sends the optimized records to the users. Platform 500 may include a reporting updating engine 505 for updating any information that is recorded and archived by the system.

Platform 500 may include a communications and or messaging queue 506 for queuing outgoing communications requests and messages and for receiving incoming requests and messages. Platform 500 may include a router 511 for routing communications and messages internally and externally. Platform 500 may include one or more data repositories analogous to repositories 113 and 115. In this example there are a plurality of dedicated repositories storing different classifications of data only to illustrate the different types of data stored and utilized during customer relations management. Platform 507 may include a data repository 507 containing a knowledge base for products, services, and brands (service or product) kept locally on the businesses registered to practice the invention. Each business entity may have a reserved portion of the repository for updating information.

Platform 500 includes a data repository 508 containing user transaction and billing history. Repository 508 contains all of the user and billing data for all of the businesses. Appropriate separation in the data including partitioning and categorization may be provided to organize the data according to desired categories for case application. Platform 500 may include a data repository 509 containing service point and contact information for all of the businesses and store locations for routing purposes. Third-party contact data may also be included in data repository 509. Platform 500 includes a data repository 510 containing reusable embeddable links and interfaces. Some widgets for example may be reusable and generic so that they might be used across business types and record types. Others are dynamically generated or otherwise specific to one or a few businesses.

In use of the invention according to one embodiment records may arrive at the domain of the platform and may be queued for processing in queue 501. Engine 502 pulls records from queue and processes those for information and user identity. Engine 502 has access to repositories 507-510. Logic 503 determines, based on the analysis what is needed in the way of linking and embedding both during optimization and when processing post transaction requests. Engine 504 accesses data held in any of repositories 507-510 in coordination with modules 502 and 503 to optimize and send the optimized record to the user. The optimized record may be queued for send in queue 506 as a message containing the record or as attached to or embedded within another media. Optimized records may be sent back to the users through router 511.

When a user responds to the optimized record by interacting with it (executing links) the requests may arrive through router 511 and may be queued for processing in queue 506. Decision logic 503 may play a part in determining whether the request can be handled internally or if it requires routing to an external resource for handling. In some cases requests might be handled internally and in an automated fashion not involving human intervention. For example, a user clicks on a link to a product FAQ page hosted in data repository 507. The page may be served to the user at a mobile or other designated computing appliance connected to the network.

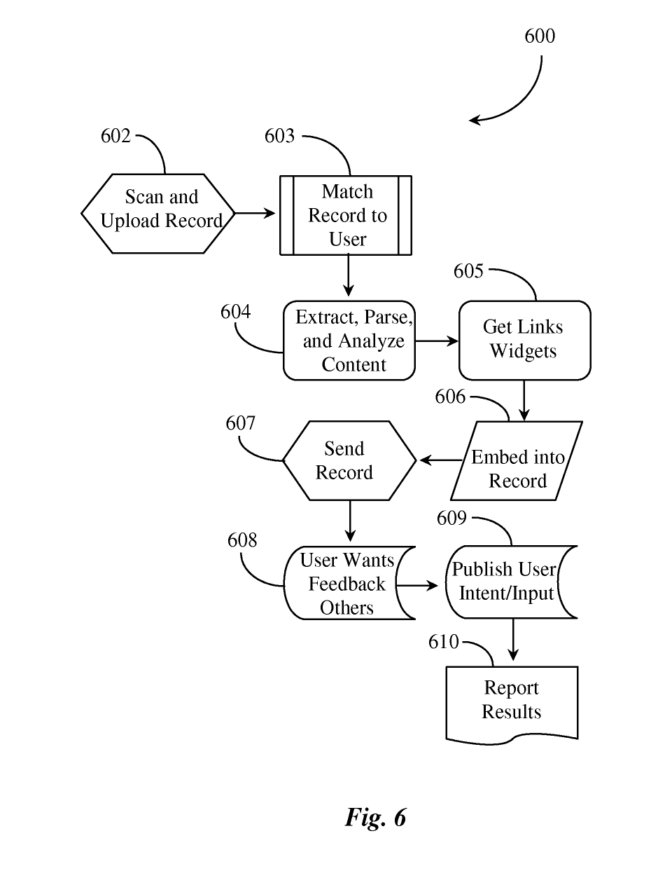

FIG. 6 is a process flow chart depicting steps 600 for brokering post-transaction communications between a user and other private individuals connected to the network according to an embodiment of the present invention. At step 602 the user may scan and upload a paper transaction record to the CRM platform server. In this example a paper receipt or other paper record is physically given to the user via a cashier or an automated machine. The server may, with the aid of SW match the record to a user at step 603. The user may be a new user requiring addition of the user to the CRM system. A user can be identified by name, number, member ID, method of payment, etc. In one embodiment the user is pre-identified during the transaction process and the identity information is included in the record or in a message containing the record or on a tag associated with the record.

At step 604, the CRM platform may extract, parse, and analyze the data in the simple digital record received at step 602. At step 605 the platform retrieves the appropriate links and widgets for inserting or embedding into the record. A set of rules or constraints may be provided to govern the amount of and types of links and widgets that may be inserted or otherwise embedded in a transaction record. Such rules may be made generally or specific to certain businesses. The rules and constraints might be applied during the data analysis phase in order to limit or regulate the number of links and widgets inserted. For example, if the record is a receipt for clothing generated as the result of a transaction at a fashion outlet, the data from analysis will point to the types of links appropriate for that record. A rule may be used to limit or regulate the number of links etc that might be provided in the optimized record.

At step 606 the CRM platform inserts or otherwise embeds the links and widgets into the record and then generates and sends a message containing the record or the record by itself to the user. The user may receive the optimized record just shortly after conducting a transaction at a physical location. In some instances the optimized record of transaction is posted or sent to a user Web page, home page, or social interaction page. Once the record is sent at step 607 the user has the opportunity to interact with the record at step 608.

In this process the user interacts with the record and the intent of the user, in this example, is to get some feedback from other users about a product or service, or some other issue that is relevant to some content in the transaction record. In a case like this the user is not requesting any information from the store or other online source. Rather the user may want to post a comment such as a question on a social interaction page for other users to respond to get some user feedback from peers. In this case the platform may publish the user's intent and input question or comment on a landing page where others may see it and respond to it. The platform may broker this activity by monitoring the communications and reporting back to the user as a service with statistics and various views of the data etc. Process 600 may be altered in step and order from this order without departing from the spirit and scope of the invention. For example, step 602 may not be necessary if the user is getting a simple digital record post transaction. Moreover, steps 608 and 609 may be different depending upon the nature of the request intent.

Links provided in the receipt or other record may enable one-touch entry points to third-party services. The links and widgets are strategically placed about the material in the record in based at least in part on understanding of content in the record and in some embodiments, the status of the user's past purchases. In one example, a communications request is about an order confirmation (order is not yet shipped) and the landing page of the link enables the user to modify the order and or to ask questions that are shipping related. In another example, the order has already shipped however links might still be provided in the shipping receipt that allow the user to ask questions about a product, or to write a review of the product or to give feedback on service of the shippers such as rating installation services, promptness, courtesy, etc.

In some embodiments templates and other information may be stored by the CRM platform unique to individual ones of businesses registered to the platform. These templates may represent specific post transaction record formats used by that particular business, and may also provide link information to be embedded at particular points in specific records.

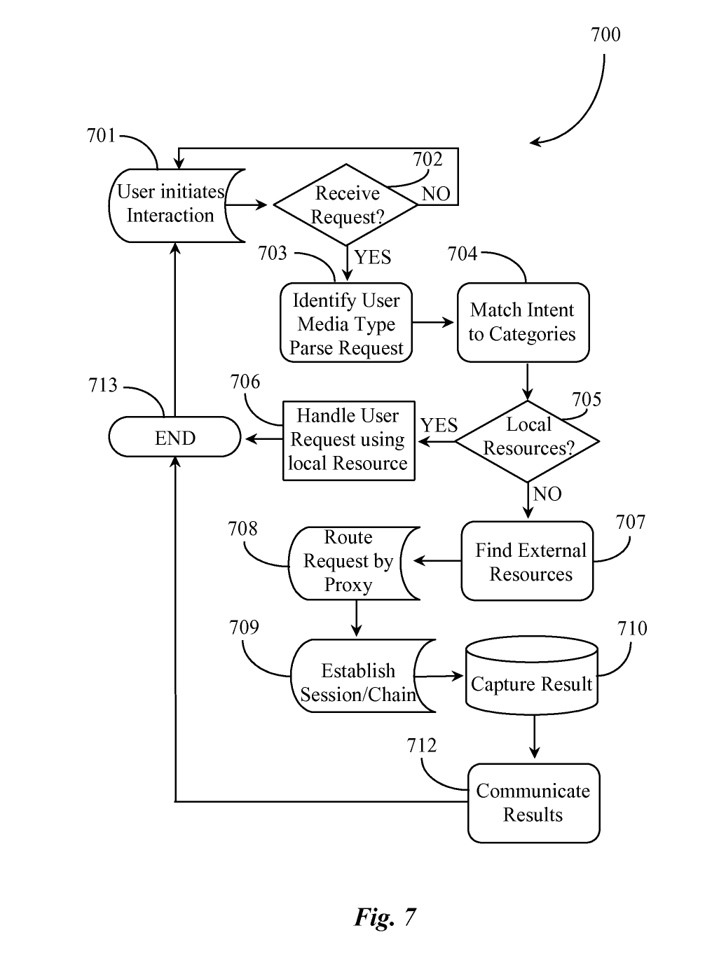

FIG. 7 is a process flow chart depicting steps 700 for auto-handling of a post transaction user request for interaction according to an embodiment of the invention. In this process it is assumed that a user has an optimized record for display and is about to initiate an interaction with the record at step 701. The interaction is tantamount to executing one of the embedded links or widgets. Such interaction generates a request unless the interaction is with a widget containing full functionality on the page using local resources such as a calculator or calendar.

At step 702 it is determined if a request from the user is received at the CRM customer interface. In one aspect the interaction does not produce a request for communication. If the system receives a communications request at step 702 the process may move to 703 where the system identifies the user media type of the request and parses the request for specific content. These steps may also be performed separately and in no specific order. In most cases the user is identified by the request record and can be matched to any pre-existing knowledge of the user in the system. A new user (first timer) may be added to the system and matched to user data later when a request from that user comes in.

In one embodiment of the invention the CRM platform might provide request categories including live or self service, product or service related, or other categories representing service offered like review, comment, etc. At step 705 the decision as to whether the request can be serviced locally or not may be made. For example, if the request is for a live service like voice or chat that is externally routed then a locally-served remedy may not apply. If the request is merely for information like a self-service product guide or a FAQ or product information page or video, then a local remedy might be applicable.

If it is determined that a local resource may be utilized to satisfy the request at step 705 then the process may move to step 706 where the user request is handled with locally available resources. At this point additional links that are context sensitive might be included in the landing page or served information or in a communicated message. The process may then end for that user at step 713 at least for the current round of interaction. The user may reuse the record to engage in more interaction at a later time.

If it is determined at step 705 that locally available resources will not satisfy the request, the process may move to step 707 where a routing application looks for and finds the external resource or resources that might satisfy the request. In one embodiment the process moves to step 708 where the request is routed to a selected destination by proxy brokering the service. In another embodiment the CRM platform does not stay in the loop after routing a request to an external resource or party. However such parties may still report back to the platform with results of the interaction or session.

A session or a communications chain like email or messaging may be established at step 709. At step 710 the platform server may capture the results of the interaction for updating the status for the user in the system. If routed destinations are third party services then the CRM platform might disengage the process and wait for results to be reported. In other embodiment other levels of coordination and service responsibilities might be arranged. The platform may communicate any interaction results to data storage and to original service locations if necessary. The process ends at step 713.

Telecommunications capabilities afforded to the entity hosting the CRM platform may dictate the extent that the platform stays involved in the process beyond optimizing the records and getting those to the users who are associated to them. Data repositories may be held locally or may be held remotely from the CRM domain without departing from the spirit and scope of the invention. In one embodiment the system manages and updates data stored at the point of sale locations of the businesses serviced by the platform reporting activity including results of post transaction communications.

In this example the post transaction interaction and communications are limited to services, offers, and actions related to the context of the record. Moreover such interaction and communications may be at least monitored if not completely hosted. In an embodiment where a request is for an outside service like mapping, the captured information might be limited to the fact that the user was provided a link to the mapping service and that the user did execute the link. Beyond that the user may be the only one privy to the actual mapping instruction received by the user through the interaction.

In one embodiment the platform has access to all of the knowledge about the user and situation including the content of the ongoing communication, the user's past purchases, the current status of the products or services purchased including shipping status such as in transit, within return window, shipped, arrived broken, etc. The landing page or the Page including, containing, or displaying the optimized record may be tailored to the context, taking advantage of all of the aforementioned knowledge. Therefore the links need only be relevant to the situation of the user relative to the record, for example, insert link “ask a product question” or “return the product” (if the product is already shipped but still within return window).

In ongoing interaction, if a user elects to “return a product” for example, the link may serve an interface that asks the user for dialog as to why the user wants to return the product. If the answer is size, fit, style or color being wrong, the service may provide a workflow for exchanging the product for one that works. The landing page is no longer a static page, but rather workflows that are tailored to user's current needs, and provide almost human-like service. Workflows are a sequence of steps that guide the customer through a process.

In a preferred embodiment, context information about the customer is auto-filled to minimize the amount of work a customer has to perform and yet provide enough information for faster problem resolution. The CRM platform of the invention may support multiple channels via channel integration. The user may option for receiving answers through email, text message, or phone call, for example. Preferences in communication may be saved for each user and reapplied in future interactions with that user. The system may broker communications (act as middleman) for example, suggesting actions like retry, auto answer, question, answer, and providing other useful suggestions. In one embodiment answers to user-posed questions might be sourced from online data sources, such as web search, and forums.

Integration with other entities may include co-branding, up-sale opportunities, or additional product or service recommendations. For example, if a service provider has sold a printer to the customer, the provider may provide recommendations for ink and paper including the sources of those products (cooperative referral system). An optimized airline ticket might include links to hotel service and auto rental. As the platform is being used, it will accumulate knowledge about problem resolution, consumer preference, knowledge about products, etc. This will enable constant improvement in user experience.

The CRM platform of the invention may also include a crowd-sourcing element that allows the question from one consumer user to be directed to other consumer, users or businesses other than the retail and brand directly involved in the order. To achieve better results, the service platform can track the purchase history of each consumer or user of the service platform. Tracking is supported by matching the itemized receipt information to shopper identity, and when a question is received about a product, the service platform can route the question specifically to the users who purchased the same product before. Such crowd sourcing service may have user opt-in and opt-out options to allow users to decide on their participation status. Such opt-in/opt-out options can also be provided on a “per question basis” so that a user can decide whether to help answering a particular question.

The service platform can also support association of a user profile to user input or activities. When the user provides input that may be published the user can choose whether to make his/her profile public or anonymous. The service platform can also rate user credibility on their answers and make such ratings available to other users using the service platform. The CRM platform of the present invention may also allow a user to follow another user in a fashion similar to twitter or Facebook following. For example, if user A follows user B, user B's comments (questions or answers) can be made available to user A when user B chooses that the comments be public or sharable.

It will be apparent to one with skill in the art that the CRM platform of the present invention may be provided as a turnkey solution as software on a non-transitory medium to a business location or entity that handles all of its own communications or that may contract with a third-party contact service. The platform may also be operated entirely by a third-party service provider marketing solutions for customer management to business entities having one or more than one place for doing business.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. An apparatus comprising:
a server connected to a network, the server including a processor coupled to at least one data repository and software executing on the processor from a non-transitory medium, the software providing a service comprising:
receipt of a transaction record related to a transaction between a business and a customer, the record in the form of a digital file generated at a location of the business;
processing of the transaction record, determining contextual meaning of individual portions of the record;
inserting into the record an executable link on or proximate a portion processed for contextual meaning, the link to a resource associated with the contextual meaning of the portion linked; and
transmitting the record with the inserted link to the customer.

2. The apparatus of claim 1 wherein the transaction record is a transaction receipt.

3. The apparatus of claim 2 wherein different portions of the transaction record identify the seller and identity of different items purchased by customer, and wherein the seller identification is made a link to an agent of the seller, and identity of items purchased are linked to information sites presenting additional information about the items.

4. The apparatus of claim 1 wherein the transaction record is one of a receipt, an invoice, a shipping notice, a service order, a ticket to travel or to an event, reservation information, or any other document motivated by a transaction between a business and a customer.

5. The apparatus of claim 1 wherein the executable link asserted by the customer initiates a browser application to service a link to a business web site, an email application to generate an email to the business, a telephony application to initiate a voice transaction to a site for the business, a texting application to initiate a text message to an agent for the business, or a chat program to initiate a chat session with an agent of the business.

6. The apparatus of claim 1 wherein the executable link has a time limit, after which the link is no longer operable.

7. The apparatus of claim 1 wherein the server provides execution of a communications initiated by the link.

8. The apparatus of claim 1 wherein the service registers a plurality of businesses as subscribers, and processes transaction records from the plurality of businesses, inserting links into the records to initiate communication between the customers and the businesses.

9. The apparatus of claim 8 wherein transaction records from individual registered businesses are received and processed in batches.

10. The apparatus of claim 8 wherein individual ones of the businesses provide templates facilitating processing of their transaction records.

11. A method comprising steps:
(a) receiving at a server connected to a network, the server including a processor coupled to at least one data repository and software executing on the processor from a non-transitory medium, a transaction record related to a transaction between a business and a customer, the record in the form of a digital file generated at a location of the business;
(b) processing of the transaction record, determining contextual meaning of individual portions of the record;
(c) inserting into the record an executable link on or proximate a portion processed for contextual meaning, the link to a resource associated with the contextual meaning of the portion linked; and
(d) transmitting the record with the inserted link to the customer.

12. The method of claim 11 wherein the transaction record is a transaction receipt.

13. The method of claim 12 wherein different portions of the transaction record identify the seller and identity of different items purchased by customer, and wherein the seller identification is made a link to an agent of the seller, and identity of items purchased are linked to information sites presenting additional information about the items.

14. The method of claim 11 wherein the transaction record is one of a receipt, an invoice, a shipping notice, a service order, a ticket to travel or to an event, reservation information, or any other document motivated by a transaction between a business and a customer.

15. The method of claim 11 wherein the executable link asserted by the customer initiates a browser application to service a link to a business web site, an email application to generate an email to the business, a telephony application to initiate a voice transaction to a site for the business, a texting application to initiate a text message to an agent for the business, or a chat program to initiate a chat session with an agent of the business.

16. The method of claim 11 wherein the executable link has a time limit, after which the link is no longer operable.

17. The method of claim 11 wherein the server provides execution of a communications initiated by the link.

18. The method of claim 11 wherein the service registers a plurality of businesses as subscribers, and processes transaction records from the plurality of businesses, inserting links into the records to initiate communication between the customers and the businesses.

19. The method of claim 18 wherein transaction records from individual registered businesses are received and processed in batches.

20. The method of claim 18 wherein individual ones of the businesses provide templates facilitating processing of their transaction records.
